(19) United States
(12) Patent Application Publication
(10) Pub. No.: US 2025/0237998 A1
(43) Pub. Date: Jul. 24, 2025

(54) Mechanical Watch And Method Of Assembling Mechanical Watch

(71) Applicant: SEIKO EPSON CORPORATION, Tokyo (JP)

(72) Inventor: Toru KAWASAKI, Shiojiri (JP)

(21) Appl. No.: 19/027,787

(22) Filed: Jan. 17, 2025

(30) Foreign Application Priority Data
Jan. 19, 2024 (JP) 2024-006689

(51) Int. Cl. G04B 37/00

(52) U.S. Cl. CPC G04B 37/0008

(57) ABSTRACT

A mechanical watch using a mainspring as a power source, in which a substantially circular movement is incorporated in a case, wherein a barrel complete storing the mainspring has a protruding portion that partially protrudes from a substantially circular outer periphery of the movement, the case has a case body portion and a bottom portion, and an inner peripheral portion of the case body portion is provided with a cutout portion that accommodates the protruding portion.

The present application is based on, and claims priority from JP Application Serial Number 2024-006689, filed Jan. 19, 2024, the disclosure of which is hereby incorporated by reference herein in its entirety.

### BACKGROUND

### 1. Technical Field

The present disclosure relates to a mechanical watch and a method of assembling a mechanical watch.

### 2. Related Art

A mechanical watch that moves hands using mechanical energy of a mainspring is known. JP-A-2017-96814 discloses a mechanical watch that includes a manual winding mechanism and winds up a mainspring stored in a barrel complete.

However, in the mechanical watch according to JP-A-2017-96814, when the barrel complete having a large number of turns of the mainspring and a large diameter is used in order to increase a duration, the barrel complete protrudes from an outer periphery of a circular movement. Therefore, in order to prevent the barrel complete from protruding from the outer periphery of the circular movement, it is necessary to increase a diameter of the movement. Consequently, there is a problem in that both an inner peripheral diameter and an outer peripheral diameter of a case accommodating the movement increase.

### SUMMARY

According to an aspect of the present disclosure, a mechanical watch in which a movement having a substantially circular shape is incorporated in a case and a mainspring is used as a power source is provided. In the mechanical watch, a barrel complete storing the mainspring has a protruding portion that partially protrudes from an outer periphery of the substantially circular shape of the movement; the case has a case body portion and a bottom portion; and an inner peripheral portion of the case body portion is provided with a cutout portion that accommodates the protruding portion.

According to an aspect of the present disclosure, a method of assembling a mechanical watch in which a movement having a substantially circular shape is incorporated in a case and a mainspring is used as a power source is provided. The method includes preparing the movement having a protruding portion in which an outer periphery of a barrel complete storing the mainspring partially protrudes from an outer periphery of the movement having the substantially circular shape, preparing the case in which an inner peripheral portion of the case body portion is provided with a cutout portion that accommodates the protruding portion, and an incorporating step of incorporating the movement in the case body portion of the case from a side opposite to a bottom portion to which a lid portion is attached, wherein in the incorporating step, the movement is incorporated such that the protruding portion is accommodated in the cutout portion.

### BRIEF DESCRIPTION OF THE DRAWINGS

FIG. 1 is a front view illustrating a schematic structure of a mechanical watch according to the present embodiment.

FIG. 2 is a cross-sectional view illustrating the schematic structure of the mechanical watch according to the present embodiment.

FIG. 3 is a plan view illustrating a structure of a main plate and a barrel complete as viewed from a case back side.

FIG. 4 is a plan view illustrating a structure of the main plate.

FIG. 5 is a plan view illustrating a structure of a case and the barrel complete.

FIG. 6 is a plan view illustrating a structure of the case and the barrel complete.

FIG. 7 is a plan view illustrating a structure of the case, the main plate, and the barrel complete.

FIG. 8 is a plan view illustrating a structure of the case and the main plate.

### DESCRIPTION OF EMBODIMENTS

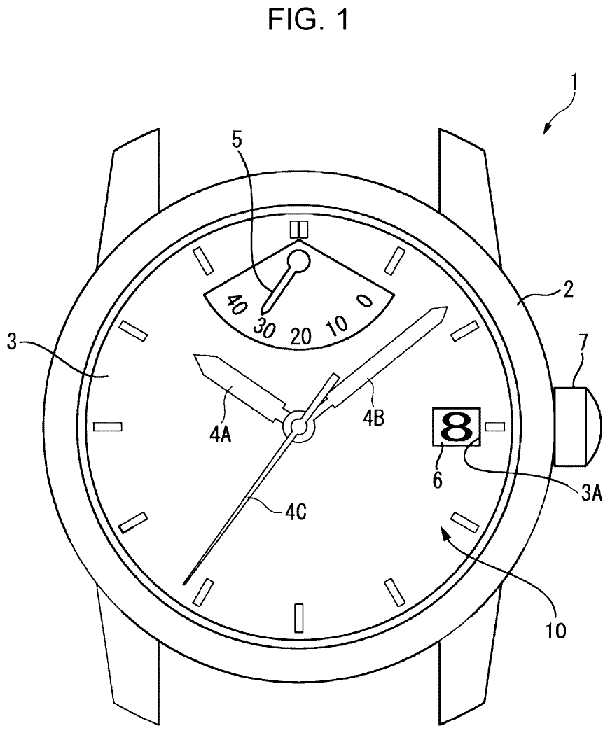

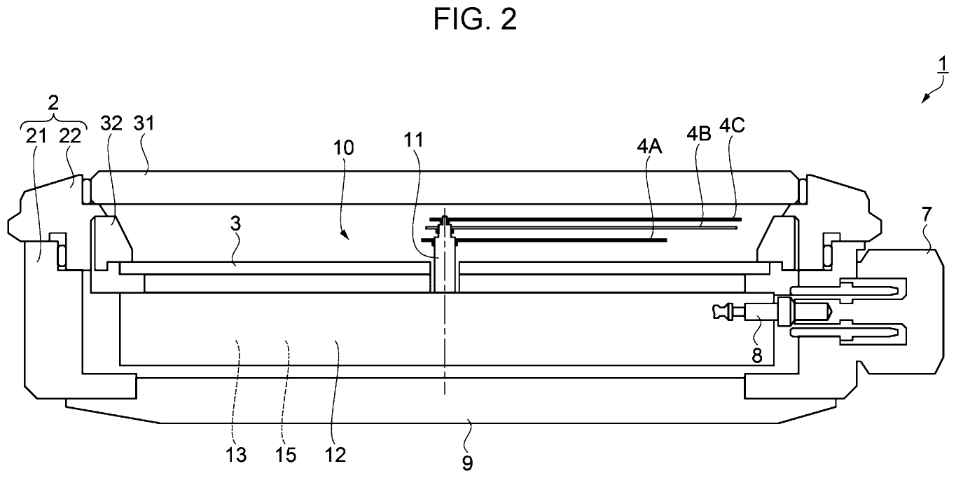

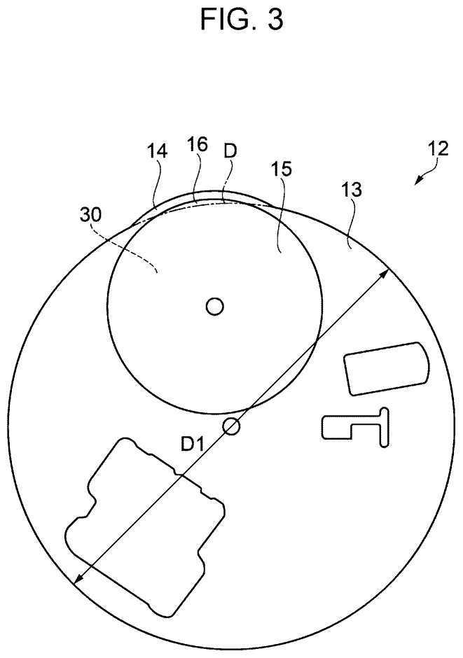

First, a wristwatch will be described as an example of a mechanical watch 1 according to the present embodiment with reference to FIGS. 1 and 2. The mechanical watch 1 according to the present embodiment is a watch using, as a power source, a mainspring 30 that is stored in a barrel complete 15 and illustrated in FIG. 3. As illustrated in FIGS. 1 and 2. The mechanical watch 1 includes a cylindrical outer case 2, a cover glass 31, and a case back 9 as a lid portion. In the mechanical watch 1, a disc-shaped dial 3 and a substantially circular movement 12 are disposed on an inner peripheral side of the outer case 2. Of two openings of the outer case 2, an opening on a front surface side is closed by the cover glass 31, and an opening on a back surface side is closed by the case back 9.

The outer case 2 is configured by fitting a ceramic or metallic bezel 22 to a metallic cylindrical case 21. The disc-shaped dial 3 is disposed on the inner peripheral side of the bezel 22 through a metallic annular dial ring 32. A crown 7 is disposed on the side of the outer case 2 at a 3 o'clock position in a time display.

The crown 7 can be pulled by two steps from a zero step position which is a normal position where the crown 7 is pushed toward a center of the mechanical watch 1. When the crown 7 is rotated at the zero step position, the mainspring 30 stored in the barrel complete 15 can be wound up. The power reserve hand 5 provided on the dial 3 moves in conjunction with the winding up of the mainspring 30. When the crown 7 is pulled to a first step position and rotated, a date can be adjusted by moving a date indicator 6. When the crown 7 is pulled to a second step position, a seconds hand 4C stops. When the crown 7 is rotated at the second step position, a time can be adjusted to move an hour hand 4A and a minute hand 4B.

A dial ring 32, a time display unit 10 including the dial 3, a power reserve hand 5 indicating a duration of the mainspring 30, and a movement 12 are accommodated in a space surrounded by the outer case 2, the case back 9, and the cover glass 31.

The outer peripheral edge of the dial ring 32 is in contact with the inner peripheral surface of the bezel 22, and the dial ring 32 has a flat plate portion with one surface parallel to the cover glass 31, and an inclined portion inclined toward the dial 3. The dial ring 32 has an annular shape in plan view, and a mortar shape in a cross-sectional view.

The time display unit 10 is driven by the movement 12 and displays the time. The time display unit 10 has hands including the hour hand 4A, the minute hand 4B, and the seconds hand 4C between the dial 3 and the cover glass 31, and is disposed inside the dial ring 32. A calendar small window 3A is provided in the dial 3 such that the date indicator 6 can be visually recognized from the calendar small window 3A.

The movement 12 is disposed between the dial 3 and the case back 9, and drives the hour hand 4A, the minute hand 4B, and the seconds hand 4C illustrated in FIG. 1 through a step motor and a train wheel. Here, the hour hand 4A, the minute hand 4B, and the seconds hand 4C are attached to a hand shaft 11 provided at a center of the plane of the dial 3. A winding stem 8 is attached to the movement 12. The crown 7 is attached to an end portion of the winding stem 8.

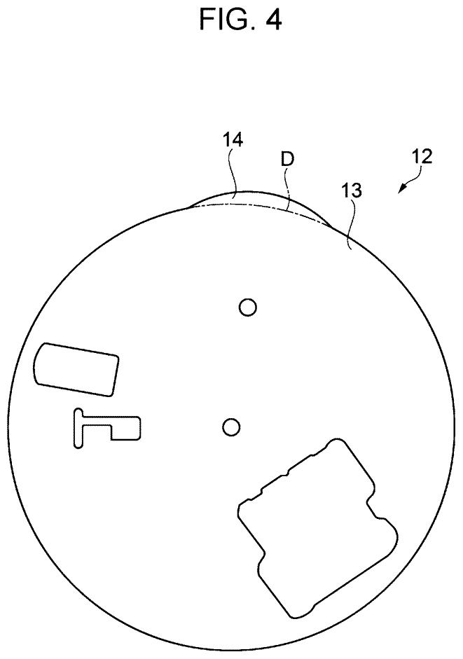

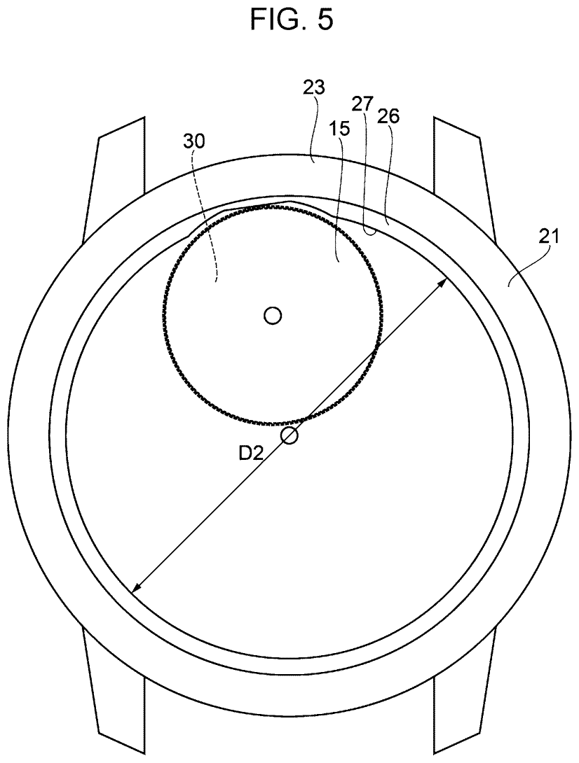

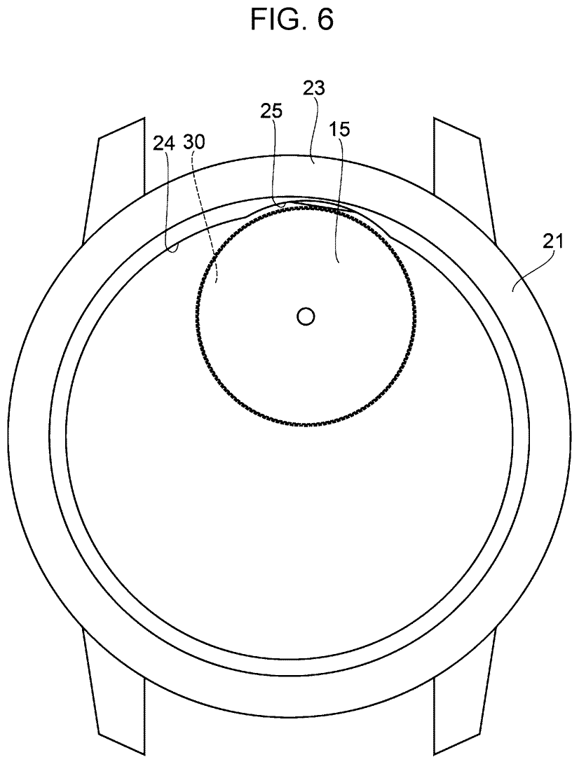

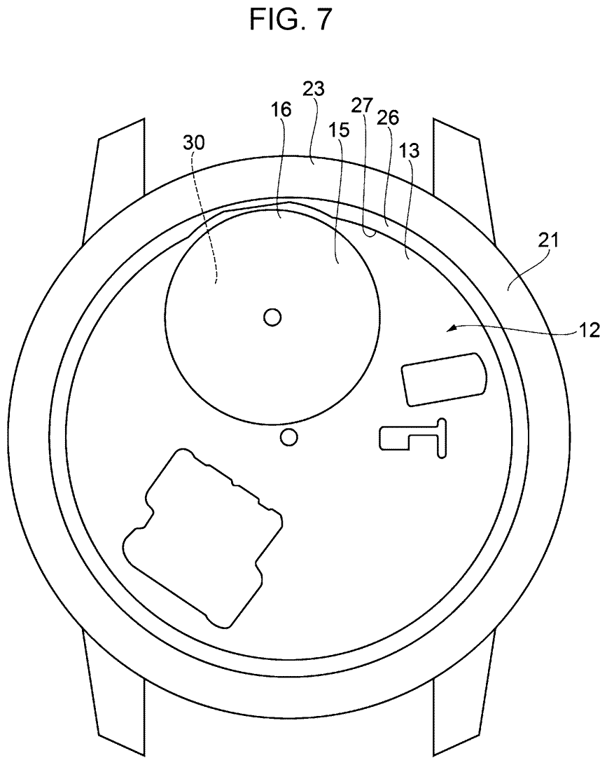

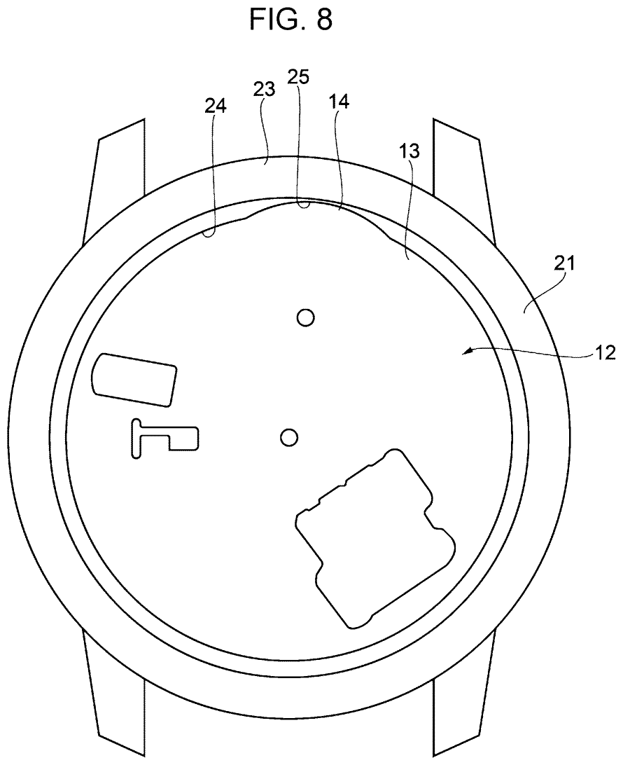

Next, a structure of a main plate 13 and the barrel complete 15 of the movement 12 and the case 21 that accommodates the movement 12 will be described with reference to FIGS. 3 to 8. FIG. 3, FIG. 5, and FIG. 7 are views from the case back side, and FIG. 4, FIG. 6, and FIG. 8 are views from the dial side.

As illustrated in FIG. 3, the movement 12 including the main plate 13 and the barrel complete 15 has a substantially circular shape having a diameter D1 indicated by an imaginary line D.

The barrel complete 15, which is fixed to the main plate 13 and stores the mainspring 30, has a circular shape and has a protruding portion 16 which partially protrudes from a substantially circular outer periphery of the movement 12 as illustrated in FIG. 3. Specifically, the barrel complete 15 has the protruding portion 16 that protrudes from an imaginary line D that indicates the substantially circular outer periphery of the movement 12.

The main plate 13 fixes the barrel complete 15 and has a main plate protruding portion 14 that protrudes from the imaginary line D indicating the substantially circular outer periphery of the movement 12 similarly to the protruding portion 16 of the barrel complete 15 as illustrated in FIGS. 3 and 4. Since the main plate protruding portion 14 of the main plate 13 has a shape similar to the protruding portion 16 of the barrel complete 15, the protruding portion 16 of the barrel complete 15 can be protected during assembly or the like.

The case 21 has a case body portion 23 and a bottom portion 26, and a cutout portion 25 for accommodating the protruding portion 16 of the barrel complete 15 is provided in an inner peripheral portion 24 of the case body portion 23 as illustrated in FIG. 6. Therefore, the barrel complete 15 having a large number of turns of the mainspring 30 and a large diameter in order to increase the duration can be accommodated in the case body portion 23 of the case 21 without increasing the outer peripheral size of the case 21. As illustrated in FIG. 8, the cutout portion 25 accommodates the main plate protruding portion 14 of the main plate 13 as well.

The cutout portion 25 is provided between 11 o'clock and 1 o'clock around 12 o'clock in the time display in a vertical direction orthogonal to a width direction, or between 5 o'clock and 7 o'clock around 6 o'clock in the time display. Since a thickness of the case body portion 23 at this position is larger than thicknesses at other positions, a decrease in a strength of the case 21 can be prevented by providing the cutout portion 25.

As illustrated in FIGS. 5 and 7, the bottom portion 26 of the case 21 has an opening 27 to which the circular case back 9 is attached, and a diameter D2 of the opening 27 is smaller than the diameter D1 of the substantially circular movement 12. Therefore, the movement 12 is assembled by being inserted into the case body portion 23 of the case 21 from the dial 3 side during assembly.

As described above, in the mechanical watch 1 according to the present embodiment, since the cutout portion 25 for accommodating the protruding portion 16 of the barrel complete 15 is provided in the inner peripheral portion 24 of the case body portion 23 of the case 21, the barrel complete 15 having a large number of turns of the mainspring 30 and a large diameter in order to increase the duration can be accommodated in the case body portion 23 of the case 21 without increasing the outer peripheral size of the case 21. Thus, the mechanical watch 1 having a long duration can be obtained.

Next, a method of assembling the mechanical watch 1 according to the present embodiment will be described. The assembling method according to the present embodiment is a method of assembling a mechanical watch 1 using a mainspring 30 as a power source, in which the substantially circular movement 12 is incorporated in the case 21. The method includes a movement preparing step, a case preparing step, and an incorporating step.

### 1. Movement Preparing Step

In the movement preparing step, the movement 12 having a protruding portion 16 in which the outer periphery of the barrel complete 15 storing the mainspring 30 partially protrudes from the outer periphery of the substantially circular movement 12 is prepared.

### 2. Case Preparing Step

In the case preparing step, the case 21 provided with the cutout portion 25 for accommodating the protruding portion 16 in the inner peripheral portion 24 of the case body portion 23 of the case 21 is prepared.

### 3. Incorporating Step

In the incorporating step, the movement 12 is incorporated in the case body portion 23 of the case 21 from a side opposite to the bottom portion 26 to which the case back 9 is attached because the diameter D2 of the opening 27, provided in the bottom portion 26 of the case 21, to which the case back 9 as the lid portion is attached is smaller than the diameter D1 of the substantially circular movement 12. That is, the side opposite to the case back 9 is a front side on which the dial 3 is located and the movement 12 can be easily incorporated in the case body portion 23 of the case 21 by inserting the movement 12 from the front side because a diameter of the dial 3 is normally larger than a diameter of the movement 12. Note that, from a viewpoint of waterproofness, an area of the case back 9 cannot be increased to a certain value or more. Therefore, a size of the opening 27 of the bottom portion 26 of the case 21 cannot be increased as well. As a result, since the movement 12 cannot be inserted from the opening on the case back 9 side, the movement 12 is inserted from the side of the dial 3 having a large opening. Further, in the incorporating step, the movement 12 is incorporated such that the protruding portion 16 is accommodated in the cutout portion 25.

Through the above steps, the mechanical watch 1 is assembled in which the protruding portion 16 of the barrel complete 15 is accommodated in the cutout portion 25 provided in the inner peripheral portion 24 of the case body portion 23 of the case 21.

As described above, in the method of assembling the mechanical watch 1 according to the present embodiment, the movement 12 is incorporated in the case body portion 23 of the case 21 from the side opposite to the bottom portion 26 to which the case back 9 is attached such that the protruding portion 16 of the barrel complete 15 can be accommodated in the cutout portion 25 of the case 21. Therefore, the barrel complete 15 having a large number of turns of the mainspring 30 and a large diameter in order to increase the duration can be accommodated in the case body portion 23 of the case 21 without increasing the outer peripheral size of the case 21. Thus, the mechanical watch 1 having a long duration can be assembled.

What is claimed is:

1. A mechanical watch in which a movement having a substantially circular shape is incorporated in a case and a mainspring is used as a power source, wherein
a barrel complete storing the mainspring has a protruding portion that partially protrudes from an outer periphery of the substantially circular shape of the movement,
the case has a case body portion and a bottom portion, and
an inner peripheral portion of the case body portion is provided with a cutout portion that accommodates the protruding portion.

2. The mechanical watch according to claim 1, wherein
the bottom portion of the case has an opening to which a circular lid portion is attached and
a diameter of the opening is smaller than a diameter of the movement having the substantially circular shape.

3. The mechanical watch according to claim 1, wherein
a main plate fixing the barrel complete has a main plate protruding portion similar to the protruding portion of the barrel complete.

4. The mechanical watch according to claim 1, wherein
the cutout portion is provided between 11 o'clock and 1 o'clock around 12 o'clock in a time display in a vertical direction orthogonal to a width direction, or between 5 o'clock and 7 o'clock around 6 o'clock in the time display.

5. A method of assembling a mechanical watch in which a movement having a substantially circular shape is incorporated in a case and a mainspring is used as a power source, the method comprising:
preparing the movement having a protruding portion in which an outer periphery of a barrel complete storing the mainspring partially protrudes from an outer periphery of the movement having the substantially circular shape;
preparing the case in which an inner peripheral portion of the case body portion is provided with a cutout portion that accommodates the protruding portion; and
an incorporating step of incorporating the movement in the case body portion of the case from a side opposite to a bottom portion to which a lid portion is attached, wherein
in the incorporating step, the movement is incorporated such that the protruding portion is accommodated in the cutout portion.
